(19) United States
(12) Patent Application Publication
(10) Pub. No.: US 2008/0236212 A1
(43) Pub. Date: Oct. 2, 2008

(54) ZIPPER LOCK

(76) Inventor: Min-Tsung MA, Chang Hua County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/836,548

(22) Filed: Aug. 9, 2007

(30) Foreign Application Priority Data
Mar. 30, 2007 (CN) 200720141284.1

(51) Int. Cl. E05B 65/00

(52) U.S. Cl. 70/77; 70/291

(57) ABSTRACT

A zipper lock includes a combination lock, a pin tumbler lock, a swivel member and two latches. The swivel member is disengaged from the latches for allowing movement of the latches when the combination lock shows the correct permutation. The pin tumbler lock has an actuating block rotatable with the key to move the swivel member away from the latches for allowing movement of the latches so as to enable the pull-tabs of the zipper be inserted into or pulled away from a lock housing of the zipper lock. Therefore, the user is allowed to selectively unlock the zipper lock either by means of the combination lock or the pin tumbler lock.

### BACKGROUND OF THE INVENTION

1. Field of the Invention

The present invention relates generally to locks and more particularly, to a zipper lock that can be unlocked forcibly.

2. Description of the Related Art

A luggage or any other similar bag or case that is provided with a zipper may be mounted with a zipper lock to lock the two zipper tabs together, prohibiting others to open the zipper.

Conventionally, a combination lock having a set of notched rotating discs is widely used as a zipper lock. When opening this kind of zipper lock, the user must rotate the notched rotating discs to show the preset combination. If the user forgets the correct combination, the user cannot open the zipper lock, and must deliver the luggage or bag to the distributor or a locksmith to open the zipper lock. Therefore, the aforesaid conventional zipper lock is not a convenient design, and may bring trouble to the user.

### SUMMARY OF THE INVENTION

The present invention has been accomplished under the circumstances in view. It is the primary objective of the present invention to provide a zipper lock, which is the assembly of a combination lock and a pin tumbler lock and allows the user to open the zipper lock through the combination lock or the pin tumbler lock selectively, enhancing the convenience of use.

To achieve this objective of the present invention, the zipper lock comprises a lock housing in which a combination lock, a pin tumbler lock, a swivel member and first and second latches engageable with two pull-tabs of a zipper which are insertable into the lock housing are mounted. When the combination lock is set in an unlocked manner from a locked manner, the swivel member is forced by a part of the combination lock to move to a position where the swivel member is disengaged from the latches for allowing movement of the latches relative to the lock housing such that the two pull-tabs of the zipper can be inserted into or pulled away from the lock housing to be engaged with or disengaged from the latches. When the combination lock is set in the locked manner from the unlocked manner, the swivel member is engageable with the latches to prohibit movement of the latches. The pin tumbler lock has an actuating block rotatable with the key to move the swivel member away from the latches for allowing movement of the latches Therefore, the user is allowed to selectively unlock the zipper lock either by means of the combination lock or the pin tumbler lock.

In a preferred embodiment of the present invention, the lock housing has a first lock notch and a second lock notch. The first latch has a locking rod movable in and out of the first lock notch. The second latch has a locking rod movable in and out of the second lock notch. Two spring members respectively bias the first latch and the second latch to support the first latch and the second latch in the first lock notch and the second lock notch in normal manner. The swivel member is moveable between a first position where the swivel member is stoppable against the first latch and the second latch to prohibit movement of the first latch and the second latch, and a second position where the swivel member is spaced from the first latch and the second latch for allowing movement of the first latch and the second latch relative to the lock housing. The combination lock includes a plurality of number wheels and a movable plate coupled to the number wheels. The number wheels each have a retaining notch. The movable plate has a plurality of retaining protrusions and a push portion. The retaining protrusions engage the retaining notches of the number wheels respectively and the push portion is stopped against the swivel member to bias the swivel member from the first position to the second position when the combination lock is unlocked. The retaining protrusions are disengaged from the retaining notches of the number wheels and the push portion is disengaged from the swivel member when the combination lock is locked. The pin tumbler lock is rotatable between a locking position and an unlocking position. The pin tumbler lock has an actuating block stopped against the swivel member when the pin tumbler lock is in the unlocking position. The actuating block is separated from the swivel member when the pin tumbler lock is in the locking position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a zipper lock according to a preferred embodiment of the present invention;

FIG. 2 is an exploded view of the zipper lock according to the preferred embodiment of the present invention;

FIG. 3 is a bottom view of the zipper lock of the present invention after removal of the bottom cover plate, showing that the combination lock is unlocked;

FIG. 4 is similar to FIG. 3 but showing that the combination lock is locked, and FIG. 5 is similar to FIG. 3 but showing that the pin tumbler lock is unlocked.

### DETAILED DESCRIPTION OF THE INVENTION

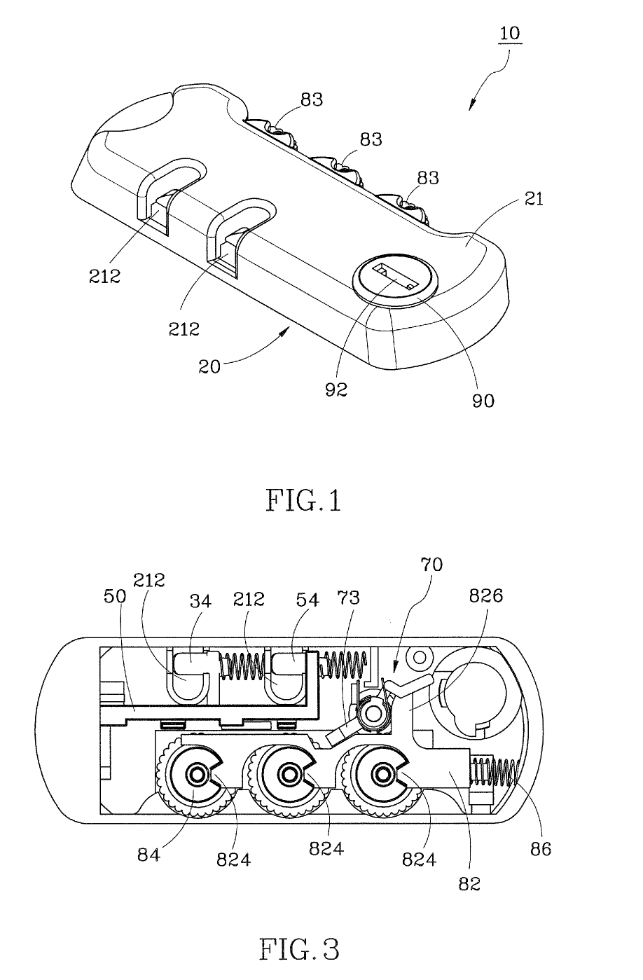

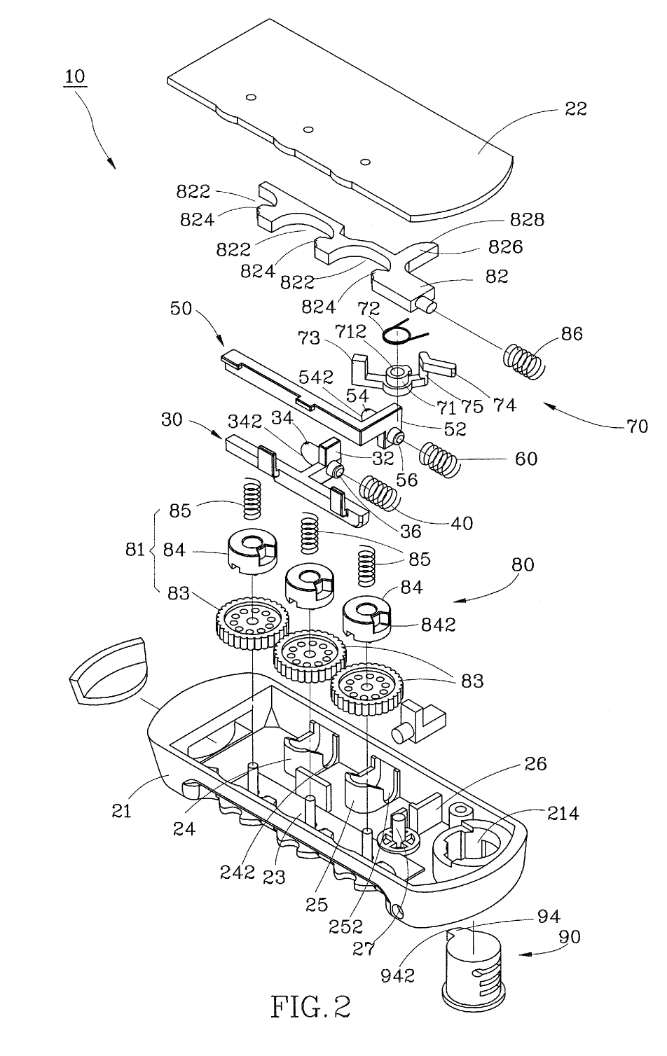

As shown in FIGS. 1 and 2, a zipper lock 10 in accordance with a preferred embodiment of the present invention comprises a lock housing 20 (see FIG. 1), a first latch 30, a first spring member 40, a second latch 50, a second spring member 60, a swivel member 70, a combination lock 80, and a pin tumbler lock 90.

The lock housing 20 includes a casing 21 and a bottom cover plate 22. The bottom cover plate 22 is covered on the bottom open side of the casing 21, defining with the casing 21 an accommodation chamber 23. The casing 21 has two lock notches 212 at one lateral sidewall thereof in communication with the accommodation chamber 23 for receiving the two pull-tabs (not shown) of a zipper (not shown), three through holes (not shown) at the other lateral sidewall in communication with the accommodation chamber 23, a pin tumbler lock hole 214 at the top wall in communication with the accommodation chamber 23, two inside flanges, namely, the first inside flange 24 and the second inside flange 25 protruding from the inside wall and respectively extending around the lock notches 212, two inside openings 242 and 252 respectively formed on the inside flanges 24 and 25, an inside stop plate 26 protruding from the inside wall and facing the opening 252 on second inside flange 25, and an inside pivot rod 27 protruding from the inside wall and disposed adjacent to the stop plate 26.

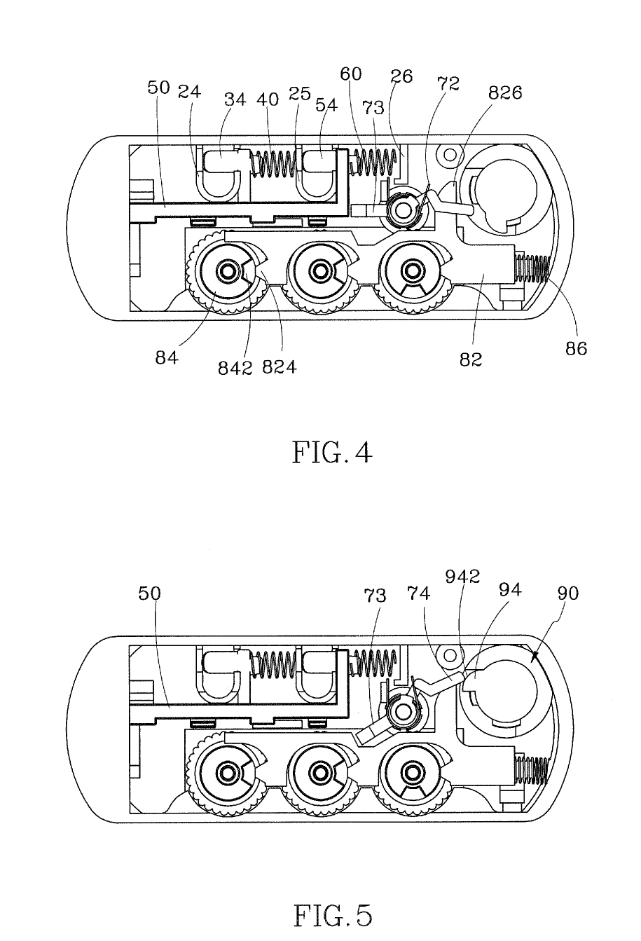

The first latch 30 is mounted in the accommodation chamber 23 of the lock housing 20, having a protrusion 32 at its one side, a locking rod 34 extending from one side of the protrusion 32 and inserted through the opening 242 on the first inside flange 24 corresponding to one lock notch 212 and stopped against the inner surface of the first inside flange 24 (see FIG. 4), and a retaining post 36 protruding from the other side of the protrusion 32. The locking rod 34 has a beveled edge 342.

The first spring member 40 is sleeved onto the retaining post 36 of the first latch 30 and stopped between the protrusion 32 of the first latch 30 and the outer surface of the second inside flange 25.

The second latch 50 is mounted in the accommodation chamber 23 of the lock housing 20 below the first latch 30, having a protrusion 52 perpendicularly extending from its one end, a locking rod 54 extending from one side of the protrusion 52 and inserted through the opening 252 on the second inside flange 25 corresponding to the other lock notch 212 and stopped against the inner surface of the associating second flange 25 (see FIG. 4), and a retaining post 56 protruding from the other side of the protrusion 52. The locking rod 54 has a beveled edge 542.

The second spring member 40 is sleeved onto the retaining post 56 of the second latch 50 and stopped between the protrusion 52 of the second latch 50 and the stop plate 26.

The swivel member 70 has a pivot portion 71, which defines a pivot hole 712 that is coupled to the inside pivot rod 27 for allowing turning of the swivel member 70 about the inside pivot rod 27 of the lock housing 20, a torsional spring 72, which works in such a manner to allow turning of the swivel member 70 about the inside pivot rod 27 within a limited angle between a first position and a second position, a stop portion 73 extending from the periphery of the pivot portion 71, a wing portion 74, and a connection portion 75 connected between the pivot portion 71 and the wing portion 74. When the swivel member 70 is in the first position as shown in FIG. 4, the stop portion 73 is stoppable against the first latch 30 and the second latch 50 to prohibit movement of the first latch 30 and the second latch 50 relative to the lock housing 20. When the swivel member 70 is in the second position as shown in FIG. 3, the stop portion 73 is moved away from the first latch 30 and the second latch 50, allowing movement of the first latch 30 and the second latch 50 relative to the lock housing 20.

The combination lock 80 is mounted in the accommodation chamber 23 of the lock housing 20, including three number wheel assemblies 81, a movable plate 82 and a spring member 86. Each number wheel assembly 81 includes a rotating disc (with inscribed numerals) 83, a retaining wheel 84, and a spring member 85. The rotating discs 83 are respectively disposed corresponding to the through holes of the casing 21 and exposed to the outside of the lock housing 20. The retaining wheels 84 are respectively disposed at the bottom side of the rotating discs 83, each having a retaining notch 842. The spring members 85 are respectively connected between the bottom side of each of the retaining wheels 84 and the bottom cover plate 22 of the lock housing 20. The movable plate 82 has three receiving open spaces 822 for receiving the retaining wheels 84 respectively, three retaining protrusions 824 respectively suspending in the receiving open spaces 822 at one side, and a push portion 826. The push portion 826 has a beveled edge 828. Further, the spring member 86 is connected between one end of the movable plate 82 and a part of the casing 21.

The pin tumbler lock 90 is mounted in the pin tumbler lock hole 214 of the casing 2I of the lock housing 20, having a keyway 92 in the top side and a bottom actuation member 94 at the bottom side. The bottom actuating block 94 has a beveled edge 942.

When wanting to open the zipper lock 10, rotate the rotating discs 81 to show the set permutation of the combination lock 80, and therefore the combination lock 80 is unlocked. At this time, as shown in FIG. 3, the retaining notches 842 of the retaining wheels 84 are respectively aimed at the retaining protrusions 824 of the movable plate 82, and the movable plate 82 is forced by the spring power of the spring member 86 toward the rotating discs 81 to engage the retaining protrusions 824 into the retaining notches 842 of the retaining wheels 84, and at the same time the beveled edge 828 of the push portion 826 of the movable plate 82 is forced against the connection portion 75 of the swivel member 70 to turn the swivel member 70 from the first position to the second position. Thus, the stop portion 73 of the swivel member 70 is disengaged from the first latch 30 and the second latch 50, making the first latch 30 and the second latch 50 moveable. The user can thus insert the two pull-tabs of the zipper into the two lock notches 212 of the casing 21. When inserting the pull-tabs of the zipper into the two lock notches 212 of the casing 21, the pull-tabs are forced against the beveled edge 342 of the locking rod 34 of the first latch 30 and the beveled edge 542 of the locking rod 54 of the second latch 50 respectively, moving the first latch 30 and the second latch 50 in direction toward the pin tumbler lock 90, and therefore the spring members 40 and 60 are compressed. After the pull-tabs of the zipper have been inserted into position in the respective two lock notches 212 of the casing 21, the first latch 30 and the second latch 50 are forced by the spring power of the associating spring members 40 and 60 to move the respective locking rods 34 and 54 into the eyelets (not shown) of the pull-tabs of the zipper. Thereafter, the user can then rotate the rotating discs 81 to move the retaining notches 842 of the retaining wheels 84 away from the retaining protrusions 824 of the movable plate 82. At this time, the retaining wheels 84 force the movable plate 82 outwards to disengage the push portion 826 from the connection portion 75 of the swivel member 70, allowing the swivel member 70 to be returned by the spring power of the torsional spring 72 from the second position to the former first position to have the stop portion 73 of the swivel member 70 be stopped against the first latch 30 and the second latch 50 again (see FIG. 4), and therefore the two pull-tabs of the zipper are locked to the lock notches 212 of the casing 21.

Referring to FIG. 5, if the user cannot remember the correct permutation of the combination lock 80, the user can insert the key into the keyway 92 of the pin tumbler lock 90 and rotate the key to move the beveled edge 942 of the bottom actuating block 94 against the wing portion 74 of the swivel member 70, thereby moving the swivel member 70 from the first position to the second position where the the stop portion 73 of the swivel member 70 is disengaged from the first latch 30 and the second latch 50 to unlock the pull-tabs of the zipper. In other words, the user can unlock the pull-tabs of the zipper by using either the combination lock 80 or the pin tumbler lock 90.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A zipper lock comprising:
a lock housing having a first lock notch and a second lock notch;
a first latch slidably mounted in the lock housing and having a locking rod movable in and out of the first lock notch;
a second latch slidably mounted in the lock housing and having a locking rod movable in and out of the second lock notch;
two spring members respectively biasing the first latch and the second latch to support the first latch and the second latch in the first lock notch and the second lock notch in normal manner;
a swivel member pivotally mounted in the locking housing and moveable between a first position where the swivel member is stoppable against the first latch and the second latch to prohibit movement of the first latch and the second latch, and a second position where the swivel member is spaced from the first latch and the second latch for allowing movement of the first latch and the second latch relative to the lock housing;
a combination lock mounted in the lock housing, the combination lock including a plurality of number wheels and a movable plate coupled to the number wheels, the number wheels each having a retaining notch, the movable plate having a plurality of retaining protrusions and a push portion, the retaining protrusions engaging the retaining notches of the number wheels respectively and the push portion being stopped against the swivel member to bias the swivel member from the first position to the second position when the combination lock is unlocked, the retaining protrusions being disengaged from the retaining notches of the number wheels and the push portion being disengaged from the swivel member when the combination lock is locked; and
a pin tumbler lock mounted in the lock housing and rotatable between a locking position and an unlocking position, the pin tumbler lock comprising an actuating block, the actuating block being stopped against the swivel member when the pin tumbler lock is in the unlocking position, the actuating block being separated from the swivel member when the pin tumbler lock is in the locking position.

2. The zipper lock as claimed in claim 1, wherein the push portion has a beveled edge for stopping against the swivel member to bias the swivel member from the first position to the second position.

3. The zipper lock as claimed in claim 1, wherein the actuating block has a beveled edge for stopping against the swivel member to bias the swivel member from the first position to the second position.

4. The zipper lock as claimed in claim 1, wherein the swivel member has a pivot portion pivoted to the lock housing, a stop portion extending from the pivot portion for stopping against the first latch and the second latch, a wing portion for stopping against the actuating block, and a connection portion connected between the pivot portion and the wing portion for stopping against the push portion.
